(19) United States
(12) Patent Application Publication
(10) Pub. No.: US 2026/0257444 A1
(43) Pub. Date: Sep. 3, 2026

(54) ROTARY PRESS AND METHOD FOR PRE-CLEANING THE PRESS HOUSING OF A ROTARY PRESS

(71) Applicant: FETTE COMPACTING GMBH, Schwarzenbek (DE)

(72) Inventors: Marcel Issmer, Lüneburg (DE); Jonas Brügmann, Schwanheide (DE)

(73) Assignee: FETTE COMPACTING GMBH, Schwarzenbek (DE)

(21) Appl. No.: 19/491,243

(22) PCT Filed: Apr. 15, 2024
(86) PCT No.: PCT/EP2024/060177

§ 371 Date: Dec. 8, 2025

(30) Foreign Application Priority Data
Jun. 27, 2023 (DE) 10 2023 116 934.3

(51) Int. Cl. B30B 15/00; B08B 3/02; B08B 3/10; B08B 5/04; B08B 13/00; B08B 15/02; B30B 11/08

(52) U.S. Cl. CPC B30B 15/0082; B08B 3/026; B08B 3/10; B08B 5/04; B08B 13/00; B08B 15/02; B30B 11/08

(57) ABSTRACT

A rotary press includes a press housing and a rotor arranged in the press housing. The rotor includes an upper and lower punch guides configured to guide upper and lower press punches, respectively, and a die plate defining a plurality of receptacles. At least one filling apparatus is configured to dispense material into the plurality of receptacles and at least one pressure apparatus is configured to press the material into pellets. The rotary press further includes a binding agent tank containing a liquid binding agent and at least one atomizing nozzle positioned inside the press housing. A conveying apparatus is configured to convey binding agent from the binding agent tank to the atomizing nozzle. The atomizing nozzle is configured to generate a spray mist of the binding agent inside the press housing to bind with dust particles.

### CROSS REFERENCE TO RELATED INVENTION

This application is a national stage application pursuant to 35 U.S.C. § 371 of International Application No. PCT/EP 2024/060177, filed Apr. 15, 2024, which claims priority to German Utility Application No. 10 2023 116 934.3, filed Jun. 27, 2023, the entire contents of which are hereby incorporated by reference.

### FIELD OF TECHNOLOGY

The following disclosure is directed to a rotary press comprising a press housing and a rotor arranged in the press housing, wherein the rotor has an upper and a lower punch guide for upper and lower pressing punches and a die plate between the punch guides, wherein the pressing punches interact with receptacles of the die plate, furthermore with at least one filling apparatus in which material to be pressed is filled into the receptacles, furthermore comprising at least one pressure apparatus which, during operation, interacts with the upper pressing punches and with the lower pressing punches so that they press material located in the receptacles into tablets, and comprising an ejection apparatus for the tablets generated in the rotary press.

The following disclosure is also directed to a method for pre-cleaning the press housing of a rotary press according to the invention and a method for inserting an atomizing nozzle into a press housing of a rotary press according to the invention.

### BACKGROUND

In rotary presses, a large number of upper and lower pressing punches are generally provided which are in each case assigned to one cavity of a die plate in pairs. During operation of the rotary press, the upper and lower pressing punches rotate together with the die plate, wherein their axial movement is controlled by means of control cams and is guided by means of upper and lower punch guides. During the course of the rotation, the die plate travels through various apparatuses of the rotary press, namely a filling apparatus, in which powder material to be pressed is guided into the cavities of the die plate, and a pressure apparatus, in which the upper and lower pressing punches are typically pressed into the cavities by means of upper and lower pressure rollers in order to press the powder material into pellets, such as tablets. Subsequent to the pressure apparatus, the upper pressing punches are guided upward out of the cavities and the pellets generated in the cavities are pushed by the lower pressing punches onto the upper side of the die plate. Ejector cams which move the lower pressing punches upward accordingly are provided for this purpose. The pellets are then scraped off the die plate, for example by a scraper, into an outlet of the rotary press, from where they are fed to further processing.

Product dust is generated during the production of tablets in rotary presses, for example when supplying the powdery material to be pressed, when pressing the material into tablets or when ejecting the tablets produced. The product dust can remain in the press housing and may have to be completely or partially removed by manual extraction when changing the product or replacing components of the rotary press, such as punches or other wear parts. In particular, the aim is to prevent press dust from entering the environment when the press housing is opened and posing a health risk there, for example in the case of pharmaceutical material. Personal protective equipment is currently used to protect operators. Dry cleaning, for example manual extraction, is known for removing product dust from surfaces of the rotary press, for example window flaps of the press housing. However, dry cleaning cannot always completely remove product dust from the surfaces or in particular from the air.

It is also known to clean rotary presses, in particular the press housing, comprehensively by spraying with a cleaning liquid. For this purpose, a cleaning liquid can be sprayed onto surfaces of the interior space of the rotary press, in particular the press housing, using a spraying apparatus in order to bind and wash off powder residues. One problem here is that, due to the amount of liquid required to clean the surfaces, liquid accumulates, in particular on horizontal surfaces of the press housing, and this liquid must be laboriously discharged after cleaning is complete. This applies in particular if the remaining cleaning liquid does not run off via drainage channels provided for this purpose under the effect of gravity due to horizontal surfaces. Liquid sitting in the press housing can also lead to corrosion of surfaces of the press housing, resulting in increased drying and cleaning effort. In addition, an external liquid supply must be connected to the rotary press in order to transfer the cleaning liquid into the inside of the rotary press.

In DE 10 2008 046 670 A1, it is therefore proposed to use an actuator to tilt the press housing or the entire tablet press machine by a tilting angle so that the cleaning liquid that has collected in the press housing can run off via a drainage channel in order to discharge cleaning liquid that has collected on horizontal surfaces. However, this involves a considerable amount of design effort and time.

Based on the prior art described, the invention is therefore based on the object of providing a rotary press and methods of the type mentioned at the beginning, with which the interior space of the press housing can be freed of product dust in an effective and, compared to the prior art, less complex manner.

### BRIEF SUMMARY OF THE INVENTION

Aspects of the following disclosure are directed to embodiments of a rotary press including a binding agent tank containing a liquid binding agent that is arranged in the press housing or outside the press housing. At least one atomizing nozzle is arranged inside the press housing and a binding agent line runs between the binding agent tank and the atomizing nozzle at least in portions inside the press housing. A conveying apparatus is provided which, during operation, conveys binding agent via the binding agent line from the binding agent tank to the atomizing nozzle, so that the atomizing nozzle generates inside the press housing a spray mist from the binding agent, which spray mist binds dust in the press housing.

Aspects of the following disclosure are directed to embodiments of a method for pre-cleaning the press housing of a rotary press according to the invention, in which a spray mist made of the binding agent is generated inside the press housing by the atomizing nozzle and, binds dust in the press housing.

The basic configuration of the rotary press, as provided according to the present invention and/or as used in the method according to the invention, was explained at the outset. As explained, the upper and lower punch guides guide the pressing punches during their axial movement. The punch heads interact with control cams that move the pressing punches in the axial direction, in particular towards and away from each other, as they rotate with the rotor. The control cams are typically made up of several control cam elements. They can accommodate the punch heads in corresponding guide receptacles or rest only against a mirror surface of the punch heads. The pressure apparatus typically comprises an upper pressure roller and a lower pressure roller, which interact with the punch heads of the upper and lower pressing punches, respectively. Several pressure apparatuses of this type can also be provided, for example pre-pressure apparatuses and main pressure apparatuses. The ejector cam as part of the control cams moves the lower pressing punches upwards after the pellets have been generated in the respective cavities, so that the respective pellets reach the upper side of the die plate, from where they can be conducted into a tablet outlet, for example by a scraper arranged in a stationary manner above the die plate.

According to some embodiments, at least one atomizing nozzle, for example two or more than two atomizing nozzles, is arranged inside the press housing. A binding agent line is provided between a binding agent tank arranged in the press housing or outside the press housing, for example on the press housing, and the atomizing nozzle and runs at least in portions inside the press housing. By means of a conveying apparatus of the rotary press, an in particular liquid binding agent is conveyed via the binding agent line from the binding agent tank to the atomizing nozzle, wherein the atomizing nozzle sprays a spray mist made from the supplied binding agent inside the press housing, which spray mist binds dust present in the press housing, in particular in the air in the press housing, namely product dust from the in particular powdery material pressed in the rotary press, and thus renders it harmless. In particular, the atomizing nozzle only generates the spray mist, i.e. it does not spray any liquid onto the surfaces of the press housing, as, for example, a cleaning lance. The dust bound by the binding agent spray mist falls slowly downwards in the press housing together with the spray mist due to gravity. The spray mist made from the liquid binding agent binds dust located in the air in the inside of the press housing on the one hand and dust located on the surfaces of the press housing on the other hand. In this way, the interior space of the press housing is freed from product dust that is problematic for an operator, for example. According to the invention, a pre-cleaning system is provided which does not claim to be a pharmaceutical cleaning system in the sense that the system can be used without further cleaning after the method according to the invention has been performed. If necessary, additional cleaning of the press housing can be carried out in accordance with the method according to the invention, for example by extracting bound dust or similar. The invention is based on the knowledge that by freeing the press housing of dust according to the invention by binding it in the manner according to the invention, access to the interior space of the press, for example, is also possible without risk and without complex additional protective measures. At the same time, the effort involved in removing the liquid from the interior space of the press when large amounts of cleaning liquid are sprayed is avoided.

In some embodiments, the binding agent is supplied from the binding agent tank, which can be installed inside the press housing or elsewhere inside the rotary press or even on the rotary press. The atomizing nozzle can be a two-substance nozzle, for example, so that an air-liquid mixture is processed by the atomizing nozzle to generate the spray mist and sprayed as a spray mist. The atomizing nozzle or else the multiple atomizing nozzles can be arranged above the rotor of the rotary press. The spray mist generated by the atomizing nozzle is distributed automatically over a wide area in the interior space of the press housing, unlike a cleaning liquid sprayed onto surfaces of the press housing by a spray lance, for example, and thus effectively binds dust in the entire interior space of the press housing. Operation of the conveying apparatus for generating the spray mist by means of the atomizing nozzle can be started, for example, by an operator, for example via a user interface of the rotary press (human-machine interface, HMI). The atomizing nozzle can be pre-mounted in the press housing or introduced as required for the process according to the invention, as will be explained in more detail below.

In some embodiments, generating a spray mist from the liquid binding agent according to embodiments of the disclosed method in which spray mist is distributed over a wide area in the press housing, a wide distribution of the spray mist in the press housing is ensured on the one hand. This eliminates the need to spray specific areas of the press housing with a cleaning liquid. The generation of a spray mist and its uniform distribution in the interior space of the press housing also prevents the accumulation of liquid on, for example, horizontal surfaces of the press housing in particular the formation of puddles. Accordingly, according to the invention, no liquid needs to be discharged from the press housing via a drain channel after the pre-cleaning process is complete, i.e. after the spray mist has been generated. Accordingly, it is possible that the press housing or else the rotary press according to the invention does not have a drain channel for draining cleaning liquid.

According to some embodiments, effective and reliable binding of dust from the material to be pressed in the rotary press takes place in a way that is less complex in terms of design and time. At the same time, corrosion of surfaces of the press housing is avoided. The dust bound by the spray mist is no longer suspended, such that it cannot be distributed in the environment even when the press housing is open and therefore cannot be inhaled by an operator. A high level of operator protection is made possible without the need for complete soaking of the press housing in the manner provided in the prior art. A drain for cleaning liquid from the rotary press, in particular the press housing, is not required. The binding agent tank and the binding agent line also eliminate the need for a costly external media supply for a cleaning liquid. By binding the dust in the air, it may be possible for an operator to open the press housing without full protection, depending on an assessment by the operator or else at the operator's responsibility. The assembly and, if necessary, disassembly of the components according to the invention is simple.

According to an embodiment, a control apparatus can be provided which is designed to control the conveying apparatus for a period of less than five minutes, preferably less than two minutes, further preferably less than one minute, in particular less than 30 seconds, further in particular less than 20 seconds, to convey the binding agent via the binding agent line from the binding agent tank to the atomizing nozzle, and thus to generate the spray mist by means of the atomizing nozzle. When the conveying apparatus is actuated, the atomizing nozzle continuously generates a spray mist from the supplied binding agent. By actuating the conveying apparatus and thus generating the spray mist according to the aforementioned embodiment only over a short period, for example a period of less than 30 seconds, a large supply of liquid into the interior space of the press housing is avoided while the dust located in the press housing is also reliably bound, such that amounts of liquid accumulating on surfaces of the press housing and thus a risk of corrosion or else the necessary discharge of these liquid accumulations are reliably avoided. The control apparatus can be integrated into a machine control system for controlling the operation of the rotary press or form a separate control apparatus.

According to a particularly practical embodiment, the binding agent tank can be arranged on an outer side of the press housing. The binding agent line can then run from the binding agent tank to the atomizing nozzle through a dust-tight opening in the press housing. In particular, the binding agent tank can be docked to the press housing via a rapid transfer port (RTP). On the one hand, this embodiment allows for particularly simple and standardized assembly of the binding agent tank, including the connection of the binding agent line between the binding agent tank and the atomizing nozzle. On the other hand, the embodiment is in particular suitable for containment presses, as it is not necessary to open the press housing and thus break the containment, or else it is possible via the dust-tight opening, for example the rapid transfer port, without breaking the containment. Accordingly, the rotary press according to the invention can be a containment rotary press, as explained below.

In some embodiments, the binding agent may comprise water and/or a cleaning agent and/or a preservative. Water is an in particular effective binding agent for product dust. As already explained, an air-water mixture can be processed by the atomizing nozzle to generate the spray mist or else applied as a spray mist. If the binding agent also contains a cleaning agent, a cleaning effect can be improved, in particular when the binding agent is deposited on surfaces of the press housing. A preservative contained in the binding agent even more reliably prevents corrosion of surfaces of the press housing that come into contact with the spray mist.

In some embodiments, the conveying apparatus comprises a compressed air apparatus that conveys the binding agent from the binding agent tank to the atomizing nozzle by means of compressed air. In this way, the binding agent can be conveyed in a in particular reliable and simple manner.

According to a further embodiment, the atomizing nozzle can be arranged pivotably in the press housing, wherein a rotary actuator is provided which pivots the atomizing nozzle in the press housing during the generation of the spray mist. The rotary actuator can pivot the atomizing nozzle in particular automatically as soon as the conveying apparatus conveys binding agent from the binding agent tank to the atomizing nozzle and the nozzle thus generates the spray mist. By pivoting the atomizing nozzle during the generation of the spray mist, a in particular large and even distribution of the spray mist in the press housing is made possible. The dust-binding effect is further improved and the risk of liquid puddles accumulating on surfaces is further reduced.

In some embodiments, the atomizing nozzle or else the multiple atomizing nozzles can be arranged on one or more nozzle blocks, with the nozzle block or else the nozzle blocks comprising the rotary actuator. The rotary actuator can be a pneumatically operated rotary actuator in an in particular practical manner. The nozzle block can also comprise a rotary distributor. It allows the binding agent line, in particular an air and/or water line, not to have to be moved when the atomizing nozzle is move.

As already explained, the atomizing nozzle or else the multiple atomizing nozzles can be arranged above the rotor in the press housing. This ensures optimum gravity-induced distribution of the spray mist in the press housing.

According to a further embodiment, it may be provided that the rotary press is a containment rotary press with an extraction apparatus, wherein the extraction apparatus generates a negative pressure in the press housing relative to the environment of the press housing. The rotary press can have, for example, a containment level of OEB3 or higher, measured for example according to the SMEPAC test (Standardized Measurement of Equipment Particulate Airborne Concentration). Such containment rotary presses are usually provided with an extraction apparatus that generates a negative pressure in the press housing relative to the environment, so that any toxic product dust cannot enter the environment but is extracted from the press housing.

According to a further embodiment, a control apparatus can then be provided which actuates the extraction apparatus during the generation of the spray mist by the atomizing nozzle in the press housing in such a way that it generates a negative pressure in the press housing relative to the environment of the press housing, wherein the spray mist is distributed in the press housing by a turbulent flow generated by the extraction apparatus. The control apparatus can be integrated into the machine controller of the rotary press or be a separate control apparatus. In particular, it can be the same control apparatus that also actuates the conveying apparatus for the binding agent and, if necessary, also actuates the rotary actuator pivot the atomizing nozzle.

In some embodiments, the extraction generates turbulent air flows in the press housing, which favor the distribution of the spray mist throughout the entire press housing, in particular also to areas that are not in the direct spray area of the atomizing nozzle, for example because they are covered by components in the press housing. Such areas can be reached advantageously by the flow generated by the extraction.

According to a further embodiment, the atomizing nozzle can be detachably arranged in the press housing. The binding agent tank and/or the binding agent line can also be detachably arranged. This also applies to a nozzle block that may hold the atomizing nozzle. In this way, it is possible to mount or dismount the components as required.

In some embodiments, the rotary press comprises a manually operable spray lance with which an operator can spray areas inside the press housing with a binding agent, in particular the binding agent from the binding agent tank. Accordingly, the spray lance can also be supplied from the binding agent tank supplying the atomizing nozzle. However, it is also possible that a separate binding agent tank, for example with a liquid cleaning agent, is provided for the spray lance. The manually operable spray lance can also generate a spray mist that binds dust in the press housing. In this way, an operator can manually spray hard-to-reach areas of the press housing that cannot be reached by the atomizing nozzle, for example a filling apparatus.

The invention also relates to a method for introducing an atomizing nozzle into a press housing of a rotary press according to the invention, in which the atomizing nozzle and optionally a nozzle block holding the atomizing nozzle are introduced outside the press housing into a container, in which the container is then introduced into the press housing via an in particular dust-tight supply opening, for example a rapid transfer port, of the press housing, and in which the atomizing nozzle and optionally a nozzle block holding the atomizing nozzle are then removed from the container inside the press housing and connected in the press housing to the binding agent line.

As already explained, it is possible for the atomizing nozzle to be detachably arranged in the press housing. In this case, the atomizing nozzle, and possibly a nozzle block holding the atomizing nozzle, must be moved into the inside of the press housing and mounted there before pre-cleaning according to the invention. In particular in the case of containment rotary presses, this should be done without opening the press housing and breaking the containment. To do this, the atomizing nozzle and, if necessary, the nozzle block must be loaded into the interior space of the press housing. Before loading, coarse dust can be extracted from the press housing using manual extraction, which is usually present in such rotary presses and may be manual, for example. In the next step, the atomizing nozzle and, if necessary, a nozzle block holding it are introduced into a container which serves to protect the atomizing nozzle or else the nozzle block. The atomizing nozzle, if necessary, with the nozzle block in the container, is then loaded into the press housing of the rotary press, namely via a preferably dust-tight supply opening, such as a rapid transfer port, of the press housing. In this way, it is possible to load the components while maintaining containment in the rotary press. In the press housing, the atomizing nozzle, with the nozzle block, if necessary, can be removed from the container and fitted in the specified position and connected to the binding agent line to the binding agent tank.

Removal of the atomizing nozzle and, if necessary, the nozzle block from the press housing during disassembly can be take place in reverse order.

### BRIEF DESCRIPTION OF THE DRAWINGS

An exemplary embodiment of the invention is explained below in greater detail based on figures.

FIG. 1 schematically illustrates an embodiment of a rotary press in a flattened representation of the rotor, according to aspects of the present disclosure.

FIG. 2 schematically illustrates an embodiment of a rotary press, according to aspects of the present disclosure.

FIG. 3 schematically illustrates a partially sectioned view of an embodiment of a binding agent tank of a rotary press, according to aspects of the present disclosure,

FIG. 4 schematically illustrates an embodiment of a nozzle block with atomizing nozzles, according to aspects of the present disclosure.

If not otherwise specified, the same reference signs denote the same subject matter in the figures.

### DETAILED DESCRIPTION OF THE INVENTION

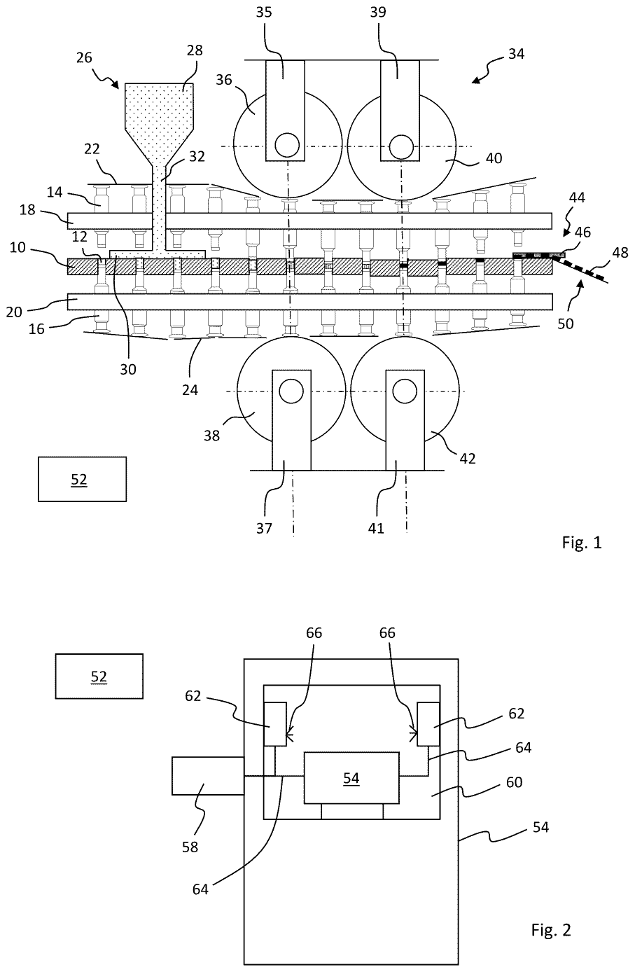

The rotary press shown in FIG. 1 is a rotary press for tablet production as can be used in the present invention and in which powdery material is pressed into tablets. The rotor of the rotary press is driven in rotation by a rotary drive and comprises a die plate 10 which has a plurality of cavities 12. The cavities 12 can be formed, for example, by bores in the die plate 10. The rotor further comprises a plurality of upper pressing punches 14 and lower pressing punches 16 which revolve synchronously with the die plate 10. The upper pressing punches 14 are axially guided in an upper punch guide 18 and the lower pressing punches 16 are axially guided in a lower punch guide 20. The axial movement of the upper pressing punches 14 and lower pressing punches 16 in the course of the rotation of the rotor is controlled by upper control cam elements 22 and lower control cam elements 24. Furthermore, a filling apparatus 26 is provided which has a filling reservoir 28 and a filling chamber 30 which are connected via a filling tube 32. In this manner, in the present example, powdered material arrives from the filling reservoir 28 via the filling tube 32 into the filling chamber 30 due to gravity and from there via a filling opening provided on the underside of the filling chamber 30 into the cavities 12 of the die plate 10, again due to gravity.

The rotary press further comprises a pressure apparatus 34. The pressure apparatus 34 comprises a pre-pressure apparatus with an upper pre-pressure roller 36 held on an upper holder 35 and a lower pre-pressure roller 38 held on a lower holder 37, as well as a main pressure apparatus with an upper pressure roller 40 held on an upper holder 39 and a lower pressure roller 42 held on a lower holder 41. Furthermore, the rotary press comprises an ejection apparatus 44 and a scraper apparatus 46 having a scraper element which supplies the tablets 48 produced in the rotary press to a discharge apparatus 50 for discharging from the rotary press. The scraper apparatus 46 can, for example, comprise a preferably crescent-shaped scraper element which scrapes tablets 48 conveyed by the lower pressing punches 16 onto the upper side of the die plate 10 in the region of the ejection apparatus 44 off of the die plate 10 and supplies them to the discharge apparatus 50.

Furthermore, the rotary press comprises a control apparatus 52 for controlling the operation of the rotary press and for performing the method according to the invention, as explained in more detail below.

FIG. 2 shows a rotary press according to the invention, which comprises a press housing 54 in which, for example, the components shown in FIG. 1 are arranged with the rotor 56. A binding agent tank 58 is arranged on the press housing 54 and can be connected to the interior space 60 of the press housing 54 in a dust-tight manner, for example via a rapid transfer port. The rotary press can be a containment rotary press in which a negative pressure is generated in the interior space 60 of the press housing 54 relative to the environment by means of an extraction apparatus arranged, for example, in the press housing 54.

In the interior space 60 of the press housing 54 in the example shown, two nozzle blocks 62 are arranged above the rotor 56, each of which holds at least one atomizing nozzle, as will be explained in more detail below. The nozzle blocks 62 and with them the atomizing nozzles are connected to the binding agent tank 58 via binding agent lines 64 shown very schematically in FIG. 2. During operation, a liquid binding agent, in particular water, to which a cleaning agent and/or a preservative can optionally be added, is supplied to the nozzle blocks 62 and with them to the atomizing nozzles by a conveying apparatus integrated into the binding agent tank 58, in particular a compressed air apparatus, so that a spray mist 66 is applied to the interior space 60 of the press housing 54 by the atomizing nozzles. This process can be controlled automatically by the control apparatus 52, in particular after the process has been started by an operator, for example via an operator terminal of the rotary press. The applied spray mist binds the dust located in the air in the interior space 60 of the press housing 54 from the powder material pressed in the rotary press and prevents the dust particles from floating in the air and thus, when the press housing 54 is opened, from escaping into the environment and posing a health risk for operators.

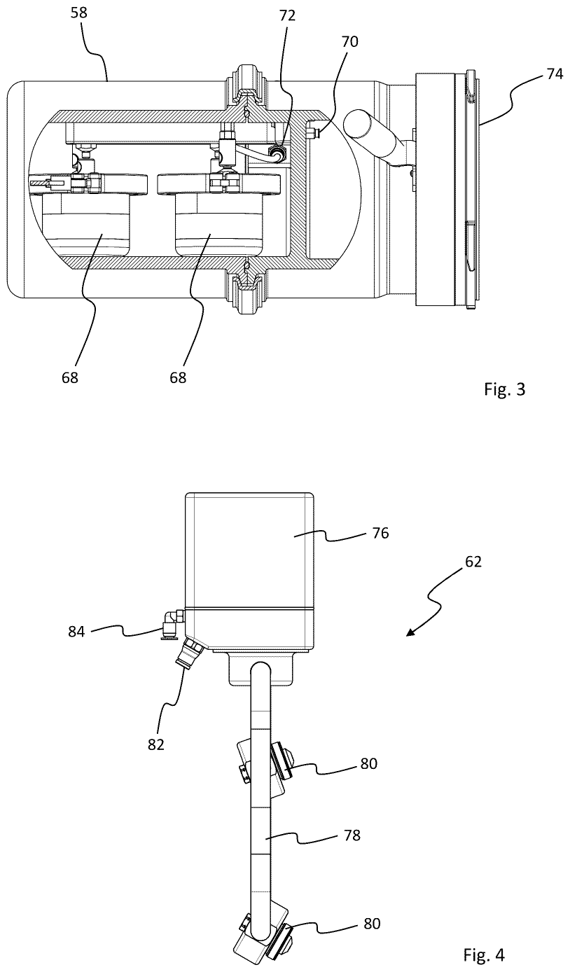

In FIG. 3, an enlarged and partially sectional representation of the binding agent tank 58 is shown. In the example shown, it comprises two tank containers 68 which are filled with binding agent and are connected to a line connection 70 to which the binding agent line 64 is connected. In addition, a compressed air supply 72 of the conveying apparatus is arranged in the binding agent tank 58 and conveys compressed air for conveying the binding agent from the tank containers 68 to the line connection 70 and via the binding agent line to the atomizing nozzles. At one end face, the binding agent tank 58 has an interface 74 for docking to the press housing 54 of the rotary press, in particular an interface 74 for connection to a rapid transfer port of the rotary press.

FIG. 4 shows one of the nozzle blocks 62 in more detail. It comprises a rotary actuator 76, to which a rod-shaped nozzle block 78 is attached, which is rotated about its longitudinal axis during operation of the rotary actuator 76, i.e. about the vertical in FIG. 4. In the example shown, two atomizing nozzles 80 are arranged on the nozzle block 78 and are aligned at an angle to one another. The binding agent line is connected to a further line connection 82 and the binding agent supplied via the line connection 82 is supplied during operation to the atomizing nozzles 80, which apply this in the press housing in the form of the spray mist, wherein the atomizing nozzles 80 are rotated as described via the rotary actuator 76 during the application of the spray mist. The rotary actuator 76 can be pneumatically actuated, for example. A pneumatic connection 84, in particular an air connection 84, is provided for this purpose. As explained, the conveying apparatus and the rotary actuator 76 can be actuated via the control apparatus 52, in particular after a pre-cleaning process has been started by an operator.

By means of the application according to the invention of the spray mist via rotating atomizing nozzles 80, in the interior space 60 of the press housing 54, a fine and dust-binding spray mist is distributed widely and evenly in the interior space 60 of the press housing 54, so that the dust is reliably bound and then sinks onto surfaces of the rotor 56 or else of the press housing 54. The pre-cleaning process with the generation of the spray mist can be performed by the control apparatus 52 for a relatively short period of less than two minutes, further preferably less than one minute, in particular less than 30 seconds, so that only a relatively small amount of liquid is applied in the interior space 60 of the press housing 54 and the risk of larger amounts of liquid accumulating on surfaces of the rotary press is minimized accordingly. An extraction apparatus of the rotary press for generating a negative in the interior space 60 of the press housing 54 supports the distribution of the spray mist, in particular through turbulent air flows.

The nozzle blocks 62 with the atomizing nozzles 80 can be detachably arranged in the press housing 54. For assembly or disassembly of the nozzle blocks 62 with the atomizing nozzles 80, these can be moved into a transfer container and transferred into the press housing 54 or out of the press housing 54 via a rapid transfer port without having to break the containment of the rotary press. It is understood that line connections 82, 84 provided on the nozzle blocks 62 for assembly or disassembly are separated from or connected to the corresponding lines.

### List Of Reference Signs

10 Die plate
12 Cavities
14 Upper pressing punches
16 Lower pressing punches
18 Upper punch guide
20 Lower punch guide
22 Upper control cam element
24 Lower control cam element
26 Filling apparatus
28 Filling reservoir
30 Filling chamber
32 Filling tube
34 Pressure apparatus
35 Upper holder
36 Upper pre-pressure roller
37 Lower holder
38 Lower pre-pressure roller
39 Upper holder
40 Upper pressure roller
41 Lower holder
42 Lower pressure roller
44 Ejection apparatus
46 Removal apparatus
48 Tablets
50 Discharge apparatus
52 Control apparatus
54 Press housing
56 Rotor
58 Binding agent tank
60 Interior space
62 Nozzle blocks
64 Binding agent line
66 Spray mist
68 Tank container
70 Line connection
72 Compressed air supply
74 Interface
76 Rotary actuator
78 Nozzle holder
80 Atomizing nozzle
82 Line connection
84 Line connection

1-19. (canceled)

20. A rotary press comprising:
a press housing; and
a rotor arranged in the press housing, wherein the rotor comprises,
an upper punch guide configured to guide upper press punches,
a lower punch guide configured to guide lower press punches, and
a die plate positioned between the upper and lower punch guides and defining a plurality of receptacles, wherein the upper and lower press punches are configured to interact with plurality of receptacles of the die plate (10);
at least one filling apparatus configured to dispense material to be pressed into the plurality of receptacles;
at least one pressure apparatus configured to interact with the upper press punches and the lower press punches during operation, to press the material in the plurality of receptacles into pellets;
an ejection apparatus configured to eject the pellets;
a binding agent tank containing a liquid binding agent;
at least one atomizing nozzle positioned inside the press housing;
a binding agent line configured to run between the binding agent tank and the atomizing nozzle, wherein at least a portion of binding agent line is positioned inside the press housing; and
a conveying apparatus configured to convey binding agent from the binding agent tank to the atomizing nozzle via the binding agent line,
wherein the atomizing nozzle is configured to generate a spray mist of the binding agent inside the press housing, and
wherein the spray mist binds with dust particles inside of the press housing.

21. The rotary press according to claim 20, further comprising a control apparatus configured to control the conveying apparatus for a period of time that is less than 5 minutes in order to convey the binding agent from the binding agent tank to the atomizing nozzle via the binding agent line.

22. The rotary press according to claim 20, wherein the binding agent tank is positioned on an outer side of the press housing.

23. The rotary press according to claim 22, wherein the binding agent line runs from the binding agent tank to the atomizing nozzle through a dust-tight opening in the press housing.

24. The rotary press according to claim 23, wherein the binding agent tank is docked to the press housing via a rapid transfer port.

25. The rotary press according to claim 20, characterized in that the binding agent comprises at least one of: (i) water; (ii) a cleaning agent; or (iii) a preservative.

26. The rotary press according to claim 20, wherein the conveying apparatus comprises a compressed air apparatus configured to convey the binding agent from the binding agent tank to the atomizing nozzle by compressed air.

27. The rotary press according to claim 20, further comprising a rotary actuator configured to pivot the atomizing nozzle in the press housing during the generation of the spray mist.

28. The rotary press according to claim 27, wherein the atomizing nozzle is positioned on a nozzle block, and wherein the nozzle block comprises the rotary actuator.

29. The rotary press according to claim 27, wherein the rotary actuator is a pneumatically operated rotary actuator.

30. The rotary press according to claim 20, wherein the atomizing nozzle is positioned above the rotor in the press housing.

31. The rotary press according to claim 20, wherein the rotary press comprises a containment rotary press with an extraction apparatus, wherein the extraction apparatus is configured to generate a negative pressure in the press housing relative to an environment of the press housing.

32. The rotary press according to claim 31, further comprising a control apparatus configured to actuate the extraction apparatus during the generation of the spray mist to generate a negative pressure in the press housing relative to the environment of the press housing, wherein the extraction apparatus is configured to generate a turbulent air flow to distribute the spray mist.

33. The rotary press according to claim 20, wherein the atomizing nozzle is detachably coupled to the press housing.

34. The rotary press according to claim 20, further comprising a manually operable spray lance configured to be used by an operator to spray areas inside the press housing with the binding agent.

35. A method for pre-cleaning a press housing of a rotary press, comprising:
structuring a rotary press to comprise,
a press housing, and
a rotor arranged in the press housing, wherein the rotor comprises,
an upper punch guide configured to guide upper press punches,
a lower punch guide configured to guide lower press punches, and
a die plate positioned between the upper and lower punch guides and defining a plurality of receptacles, wherein the upper and lower press punches are configured to interact with plurality of receptacles of the die plate,
at least one filling apparatus configured to dispense material to be pressed into the plurality of receptacles,
at least one pressure apparatus configured to interact with the upper press punches and the lower press punches during operation, to press the material in the plurality of receptacles into pellets,
an ejection apparatus configured to eject the pellets,
a binding agent tank containing a liquid binding agent,
at least one atomizing nozzle positioned inside the press housing,
a binding agent line configured to run between the binding agent tank and the atomizing nozzle, wherein at least a portion of binding agent line is positioned inside the press housing, and
a conveying apparatus configured to convey binding agent from the binding agent tank to the atomizing nozzle via the binding agent line;
generating a spray mist of the binding agent inside the press housing; and
binding dust particles inside of the press housing via the spray mist.

36. The method according to claim 35, further comprising inhibiting binding agent from flowing out of the press housing after pre-cleaning is complete.

37. The method according to claim 36, further comprising actuating the conveying apparatus for a period of time that is less than 5 minutes in order to convey the binding agent from the binding agent tank to the atomizing nozzle.

38. A method for introducing an atomizing nozzle into a press housing of a rotary press according to claim 20, further comprising:
structuring a nozzle block to hold the atomizing nozzle;
introducing the atomizing nozzle into a container outside the press housing;
introducing the container into the press housing via a supply opening in the press housing; and
removing the atomizing nozzle from the container inside the press housing and connected to the binding agent line in the press housing.
